(19) United States
(12) Patent Application Publication
(10) Pub. No.: US 2024/0028537 A1
(43) Pub. Date: Jan. 25, 2024

(54) Hidden Flow Discovery

(71) Applicant: Mastercard International Corporation, Purchase, NY (US)

(72) Inventors: Nicola Mariella, Oranmore (IE); Stephen Patrick Flinter, Tenenure (IE)

(21) Appl. No.: 18/081,999

(22) Filed: Dec. 15, 2022

(30) Foreign Application Priority Data
Dec. 20, 2021 (GB) 2118538.4

(51) Int. Cl. G06F 13/38; G06N 10/60

(52) U.S. Cl. CPC G06F 13/38; G06N 10/60; G06F 2213/40

(57) ABSTRACT

An internal flow determination method comprising the steps of: receiving, at a classical computer, an input flow vector comprising a plurality of input entries. Then, receiving an output flow vector comprising a plurality of output entries. Said output entries are indicative of a monetary amount exiting the processing node. Determining an objective optimization problem subject to one or more constraints, wherein an objective of the objective optimization problem is to determine: an input flow matrix and an output flow matrix. Then, determining a quadratic unconstrained binary optimization (QUBO) formulation suitable for implementing the objective optimization problem. Solving, by a quantum computer, the QUBO formulation, thereby providing a solution representative of the input flow matrix and the output flow matrix. Finally, generating, by the classical computer, a probability matrix indicative of a probability that an internal flow of the processing node connects an input entry to an output entry.

### TECHNICAL FIELD

The present disclosure relates to quantum computing. In particular, the present disclosure relates to a computer-implemented method and corresponding computing device for determining and/or identifying a connection between an input fund and an output fund.

### BACKGROUND

Quantum computers exploit the quantum superposition characteristics of particles to determine the optimal solution to complex non-linear problems. Unlike classical computers where a classical memory bit will take either a value of “1” or a value of “0”; in a quantum computer, a quantum bit or “qubit” may take a value of “1”, “0” or a superposition of “1” and “0”. By resolving the value of a plurality of qubits, the quantum computer can determine the minimum energy state of the qubits and so determine in one computation cycle the optimum solution to a given problem.

In order to exploit the processing efficiency of a quantum computer to solve a complex real world problem, the real world problem and variable may need to be expressed to the quantum computer in a resolvable manner. Determining how to express the problem and variables may be a computationally expensive or complex task which may require more processing cycles than would be needed to solve the problem using a traditional iterative method.

A cryptocurrency tumbler is a service which mixes potentially identifiable cryptocurrency funds with others. These funds may be obtained by any means, credible or non-credible, and the mixing effectively obscures the trails back to the funds original source. This mixing of funds is done by gathering a plurality of source funds over a period of time, aggregating and mixing the source funds, and outputting the aggregated and mixed funds to destination addresses. Due to the mixing, it is difficult to determine a source of the funds. Accordingly, cryptocurrency tumblers are used in money laundering.

Determining the source of the funds is a computationally complex tax.

The present disclosure has been devised to mitigate or overcome at least some of the above-mentioned problems.

### SUMMARY OF THE DISCLOSURE

In accordance with a first aspect of the present disclosure, there is provided an internal flow determination method comprising the steps of: receiving, at a classical computer, an input flow vector comprising a plurality of input entries, said input entries being indicative of a monetary amount entering a processing node; receiving, at a classical computer, an output flow vector comprising a plurality of output entries, said output entries being indicative of a monetary amount exiting the processing node; determining, by the classical computer, an objective optimization problem subject to one or more constraints; wherein an objective of the objective optimization problem is to determine: an input flow matrix; and an output flow matrix; determining, by the classical computer, a quadratic unconstrained binary optimization (QUBO) formulation suitable for implementing the objective optimization problem; solving, by a quantum computer, the QUBO formulation, thereby providing a solution representative of the input flow matrix and the output flow matrix; and generating, by the classical computer, a probability matrix indicative of a probability that an internal flow of the processing node connects an input entry to an output entry.

The method advantageously provides a means for identifying a likelihood indicative of a link between an input fund of a plurality of input funds, and an output fund of a plurality of output funds, the output funds being an output of the processing node. The input fund may be a fund originating from an illegitimate source, such that the output funds comprise a laundered fund. The processing node may be a cryptocurrency tumbler configured to mix legitimate funds with illegitimate funds.

Preferably, the probability matrix is obtained by multiplying the input internal flow matrix by a transpose of the output internal flow matrix.

Preferably, the probability matrix is an m by n matrix having entries indicative of a flow probability between an input fund and an output fund, wherein m is a vector length of the output flow vector, and wherein n is a vector length of the input flow vector.

Preferably, the one or more constraints comprise: a left-stochastic constraint; and an integer constraint.

Preferably, the left-stochastic constraint is configured to ensure that the input flow matrix and the output flow matrix are left-stochastic.

Preferably, the integer constraint is configured to limit entries of the input flow matrix and entries of the output flow matrix to the group of integers modulo 2.

In some embodiments, the one or more constraints further comprise: a synchronicity constraint; and a biasing constraint.

Preferably, the synchronicity constraint is configured to ensure that a time value associated with entries of the input flow vector is earlier than a time value associated with entries of the output flow vector that are linked to the entries of the input flow vector.

Preferably, the biasing constraint is configured to bias the solution according to patterns determined by a machine learning algorithm.

Preferably, the QUBO formulation is solved by an adiabatic quantum computer.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

One or more embodiments of the disclosure will now be described, by way of example only, with reference to the accompanying drawings, in which:

FIG. 1 is a computing system;

FIG. 2 is a method for identifying a connection likelihood between an input fund and an output fund;

FIG. 3 is an estimated flow between a plurality of input funds and a plurality of output funds; and

FIG. 4 depicts a flow between a plurality of input funds and a plurality of output funds through a processing node.

### DETAILED DESCRIPTION

### Quadratic Unconstrained Binary Optimisation

A real world problem may be formulated as an objective optimisation problem subject to a number of constraints. The objective optimisation problem may be a combinatorial problem that fits the QUBO (Quadratic Unconstrained Binary Optimisation) form. A QUBO problem is a form of discrete optimisation problems that involves finding a set x of N binary variables {xᵢ} that minimises the objective problem, defined as:

E(x)=x^{T}Qx

Where Q is an N×N matrix comprising elements qᵢⱼ that is characteristic of the real world problem, wherein elements qᵢⱼ preferably represent a weight (or a coefficient). Q may be in either a symmetric or upper triangular form. The x term represents a vector having a range of binary values, 0 or 1, i.e. x∈{0, 1}. The diagonal terms of Q represent linear terms whilst the off-diagonal terms of Q represent quadratic terms. Accordingly, the objective problem is defined by the above equation.

A significant application of QUBO emerges from its equivalence to the Ising model, wherein the energy of a configuration of the (sing model is given by a Hamiltonian function defined by a first term and a second term as:

$$H ( σ ) = - {\sum }_{( i j 〉} {J}_{i j} {σ}_{i} {σ}_{j} - μ {\sum }_{j} {h}_{j} {σ}_{j}$$

The first term −Σ [symbol] ᵢⱼ [symbol] Jᵢⱼσᵢσⱼ corresponds to an interaction (or coupling strength) Jᵢⱼ between a first site i and a second site j. The first site may have a first spin, σᵢ and the second site may have a second spin, σⱼ, each spin having a value of +1 or −1, i.e. σ∈{−1, 1}ⁿ. The notation [symbol] ij [symbol] indicates that the first site and the second site are nearest neighbours, wherein each pair of sites is counted once. The second term, −μΣⱼhⱼσⱼ represents an interaction between the system and an external bias hⱼ, for example a transverse magnetic field. The external bias is generated by the bias device 144. Therefore, hⱼ is a strength of the magnetic field interacting with the site j having a spin σⱼ. Importantly, interaction Jᵢⱼ and bias hⱼ are programmable parameters that may be adjusted. The Ising model may be translated into a QUBO problem, or vice versa, by defining xᵢ=(σⱼ+1)/2. Accordingly, the QUBO problem advantageously maps to the Ising model which, following the quantum annealing process, leads to a ground state solution corresponding to a minimised solution of the real world problem. Accordingly, the objective problem is implemented by the quantum computing unit as a Hamiltonian with adjustable parameters Jᵢⱼ and hⱼ. Importantly, a length of vector x corresponds to the number N of qubits required to represent the objective optimisation problem.

Accordingly, the QUBO framework may express a real world problem as an energy function which can be provided to the quantum computer. The variables identified in relation to the real world problem are mapped to the variables of the QUBO energy function. The QUBO energy function may be thought of as a matrix wherein each value in the matrix expresses the relationship between two different qubits in the quantum computer. For simplicity some embodiments herein may be described in terms of a problem expressed in a two-dimensional QUBO matrix. However, other embodiments may express problems in terms of three or more dimensions. Once the energy function has been input to the quantum computer, the physical properties of the quantum computer will cause the function to resolve to a minimum value landscape which may be output as an optimisation of the result.

The present disclosure relates to a computer-implemented method.

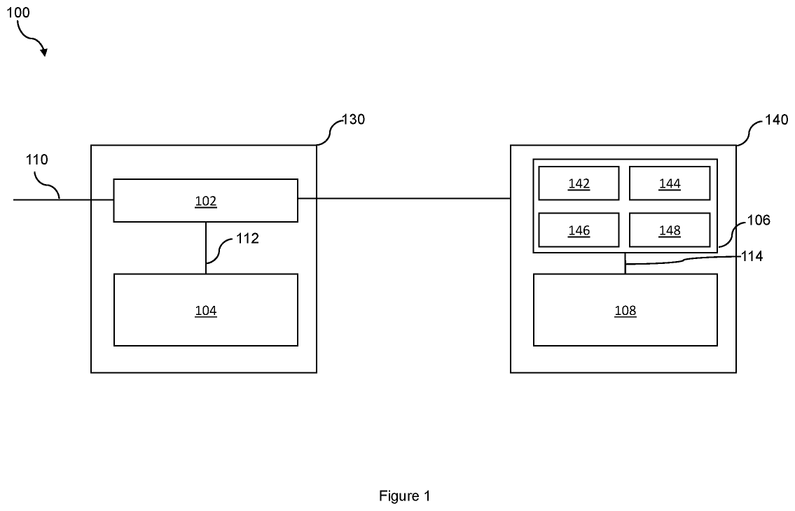

FIG. 1 shows a computing system 100 comprising a classical computer 130 coupled to a quantum computer 140.

The classical computer 130 comprises a CPU 102 coupled to a conventional memory 104 by means of a memory interface 112. Input information may be received by the CPU from an interface 110. Output information may be provided by the CPU to the interface 110. The classical computer 130 may further comprise additional classical computing elements as known in the art (not shown).

The quantum computer 140 comprises a quantum computing unit 106 and a quantum memory unit 108, a plurality of coupling devices 142, a bias device 144, and a state determination device 146. The quantum computing unit 106 comprises a number N of qubits 148. The qubits 148 may be for example, superconducting flux devices 148 having a circulating current. For example, the superconducting flux devices 148 may comprise a loop of superconducting material interrupted by at least one Josephson junction, as is known in the art. Further qubit implementations may be envisaged. The quantum computing unit 106 is configured to provide transactions to, and receive transactions from, the quantum memory unit 108 by means of a memory interface 114. A “state” of the quantum computing unit 106 corresponds to the respective state of all of the N qubits. An example state of a qubit is a 0 state. The 0 state may correspond to, for example, a clockwise current around the superconducting flux devices 148 which may induce a downward magnetic field. A counter clockwise current around the superconducting flux devices may induce an upwards magnetic field which references a state 1. The state of the quantum computing unit 106 may be described by a bit string having a length N. Thus, there are 2N possible configurations for the state of the quantum computing unit 106. The quantum computer 140 is a quantum annealer. Other quantum computing models may be envisaged.

The coupling interaction of the Ising model may be implemented by coupling devices of a quantum computer which preferably couples (or entangles) a first qubit with a second qubit. The coupling device or devices may be, for example, a superconducting loop. The coupling between the first qubit and the second qubit is either ferromagnetic or anti-ferromagnetic as the qubits interact via their respective magnetic fluxes. A change in flux of the first qubit will affect the flux of the second qubit. If the coupling is ferromagnetic (i.e. Jᵢⱼ>0), it is energetically favourable for a change in flux of the first qubit to produce a similar change in the flux of the second qubit. Accordingly, a clockwise superconducting current in the first qubit will cause a clockwise superconducting current in the second qubit to be more energetically favourable than a counter-clockwise superconducting current. In this case, the first qubit and the second qubit will tend towards the 0 state. If the coupling is anti-ferromagnetic (i.e. Jᵢⱼ<0), it is energetically favourable for a change in the flux of the first qubit to cause an opposite effect in the flux of the second qubit. Accordingly, a clockwise superconducting current in the first qubit will cause a counter-clockwise superconducting current in the second qubit to be more energetically favourable than a clockwise superconducting current. In this case, the first qubit will tend towards the 0 state and the second qubit will tend towards the 1 state.

### Cryptocurrency Tumbler

A cryptocurrency tumbler is a service that mixes a cryptocurrency transaction with other cryptocurrency transactions, with a purpose being to prevent the discovery of an originating party of the transaction. In particular, cryptocurrency is sent to the tumbler and the tumbler relays the transaction whilst hiding the sender's address. The cryptocurrency may be split up, concatenated, and/or mixed in order to randomise the transaction. The tumbler has found particular use with money laundering because illegitimate parties are able to mix their illegitimate funds with legitimate funds, thereby reducing the likelihood of a third party determining the source of the illegitimate funds.

Since cryptocurrencies, such as Bitcoin, operate using a blockchain, every transaction may be read by anyone by downloading the entire blockchain. Accordingly, it is possible to determine the transaction that is input to the tumbler, as well as the output.

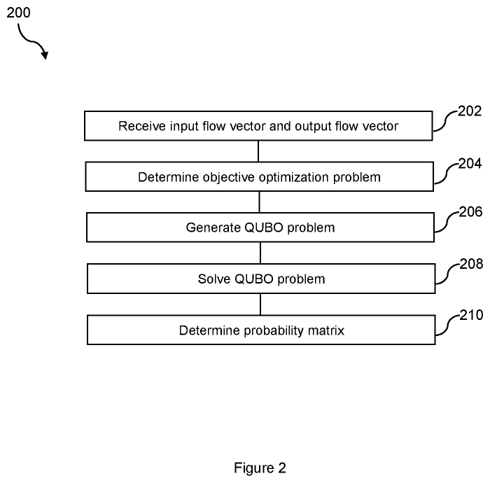

FIG. 2 shows a method 200 for using the computing system 100. In particular, the method 200 provides a connection likelihood between the input fund and the output fund after the input fund has been processed by a cryptocurrency tumbler (herein referred to as “processing node”).

In a first step 202 of the method 200, the classical computer 130 receives an input flow vector x and an output flow vector y. The input flow vector x and the output flow vector y may be received by downloading a blockchain comprising transactions representative of the input funds and the output funds.

The input flow vector x is a vector having n entries xᵢ, representative of funds that have been input to a processing node. Each entry xᵢ, of the input flow vector x corresponds to a particular monetary amount entering the processing node. For example, an input flow vector x of vector length 7 (i.e. n=7) represents 7 distinct funds entering the processing node. The monetary amounts may originate from either an illegitimate source or a legitimate source. The skilled addressee will understand that the term “tainted source” means a source that has acquired funds via illegitimate means. In the present example, a first tainted source input x₁ is 5.431621 units, wherein the units represent any monetary value, such as cryptocurrency. A second legitimate source input x₂ is 0.647663 units, a third legitimate source input x₃ is 1.76037 unit, a fourth tainted source input x₄ is 4.640703 units, a fifth legitimate source input x₅ is 8.930766, a sixth legitimate source input x₆ is 0.469607, and a seventh tainted source input x₇ is 9.180342 units. Accordingly, the input flow vector x is:

$$x = ( \begin{matrix}5.43 1621 \\ 0.64 7663 \\ 1.76037 \\ 4.640703 \\ 8.930766 \\ 0.46 9607 \\ 9.18 0342\end{matrix} )$$

The output flow vector y is a vector having m entries yⱼ representative of funds that have been output by a processing node. Each entry yⱼ of the output flow vector y corresponds to a particular monetary amount output by the processing node. For example, an input flow vector y of vector length 5 (i.e. m=5) represents 5 distinct funds output by the processing node. The monetary amounts correspond to a mixture of the input funds from the tainted and legitimate sources. In the present example, a first output y₁ is 2.673164 units, a second output y₂ is 11.410319 units, a third output y₃ is 3.185371 units, a fourth output y₄ is 8.0468237 units, and a fifth output y₅ is 5.745395 units. Accordingly, the output flow vector y is:

$$y = ( \begin{matrix}2.67 3164 \\ 11.4 10319 \\ 3.18 5 \; 371 \\ 8.04 68237 \\ 5.74 5395\end{matrix} )$$

Notably, the input flow vector does not necessarily comprise the same vector length as the output flow vector. This is because the processing node may, in addition to splitting and mixing, aggregate the input funds such that tainted funds are mixed in with legitimate funds.

The input and output flow vectors x,y are subject to a plurality of constraints, including a non-negative constraint, and a continuity constraint. The non-negative constraint requires that the monetary amounts of the input and output flow vectors x,y are non-negative, such that all entries of the vectors x,y are positive. The continuity constraint requires that an input monetary amount sum of the input flow vector x is equal to an output monetary amount sum of the output flow vector y:

$${\sum }_{i} {x}_{i} = {\sum }_{j} {y}_{j}$$

At step 204, an objective optimization problem is determined. An objective of the objective optimization problem is to determine an input flow matrix Pₓ and an output flow matrix P_{y}. The input flow matrix Pₓ is a matrix of size k×n, whilst the output flow matrix P_{y} is a matrix of size k×m, wherein a magnitude of k is the lower vector length of the input flow vector x and the output flow vector y, such that k=min (m,n). In the present example, k=5 because the output flow vector y has a lower vector length of 5. Accordingly, the input flow Pₓ is a matrix of size 5×7, and the output flow matrix P_{y} is a matrix of size 5×5.

The objective optimization problem is:

min_{P}_{ₓ}_{,P}_{_{y}}|Pₓx−P_{y}y|²

The input expression Pₓx and the output expression P_{y}y determine two vectors, each having k elements representative of an internal routing of the processing node

The objective optimization problem is subject to a plurality of constraints, including: a left-stochastic constraint; and an integer constraint.

The left-stochastic constraint is a requirement that the input flow matrix Pₓ and the output flow matrix P_{y} is that both are both left stochastic, such that each column sums to 1. That is, JₗPₗ=Jₗ wherein Jₗ is a matrix of ones having a matrix size suitable for matrix multiplication and l∈{x,y}. In particular, the left-stochastic constraint is:

JₓPₓ=Jₓ,J_{y}P_{y}=J_{y}

The integer constraint is configured to limit the entries (Pₓ)_{i,j} and (P_{y})_{i,j} of the input flow matrix Pₓ and the output flow matrix P_{y}, respectively, to the group of integers modulo 2. In particular, the integer constraint is:

(Pₓ)_{i,j}∈ [symbol] ₂,(P_{y})_{i,j}∈ [symbol] ₂

The skilled addressee will understand that additional constraints may be envisaged, such as constraints configured to enforce synchronicity between the input flow vector x and the output flow vector y. That is, a constraint configured to ensure that all entries of the input flow vector x are associated with a time preceding a time associated with the entries of the output flow vector y. Further constraints may be envisaged, for example a biasing constraint configured to bias the solution to patterns determined by a machine learning algorithm.

The objective optimization problem may be expanded as:

|Pₓx−P_{y}Y|²=(Pₓx−P_{y}y)_{T}·(Pₓx−P_{y}y)

Accordingly, the expanded objective optimization problem is in a quadratic form with respect to the variables (Pₓ)_{i,j} and (P_{y})_{i,j}.

At step 206, a quadratic unconstrained binary optimization (QUBO) problem is generated based on the objective optimization problem. The skilled addressee will understand how to generate the objective optimization problem, for example following Glover, Fred; Kochenberger, Gary (2019). “A Tutorial on Formulating and Using QUBO Models”. Furthermore, the skilled addressee will understand that the left-stochastic constraint and the integer constraint may both be converted into quadratic penalty terms. Accordingly, the objective optimization problem may be solved by a QUBO solver, such as the quantum computer 140, following step 206.

The input flow matrix Pₓ and the output flow matrix P_{y} may be converted into a form suitable for being solved as a QUBO problem. The input flow matrix Pₓ and the output flow matrix P_{y} may be converted into a vector with columns stacked on each other. In particular, each row of the respective matrices may be converted into a corresponding column, which may be subsequently concatenated, thereby generating an equivalent vector.

At step 208, the QUBO problem is solved by the quantum computer 140. The solution provides the entries of the input flow matrix Pₓ and the output flow matrix P_{y}.

At step 210, after receiving the solution from the quantum computer 140, a probability matrix F is determined by the classical computer 130. The probability matrix F is determined by the matrix product of the transpose output flow matrix P; and the input flow matrix Pₓ:

F=P_{y}^{T}Pₓ

The probability matrix F is therefore an m×n matrix having entries indicative of a flow probability between an input fund xᵢ and an output fund yⱼ. In particular, each row Fⱼ of the probability matrix F corresponds to a respective output fund yⱼ, and each column Fᵢ of the probability matrix F corresponds to a respective input fund xᵢ. Accordingly, the presence of, for example, a 1 on row j and column i is indicative of a likely flow from the input fund xᵢ and the output fund yⱼ.

For the present example, the probability matrix F determined based on the input flow vector x and the output flow vector y is:

$$F = [ \begin{matrix}1 / 3 & 1 / 3 & 0 & 1 / 3 & 0 & 0 & 0 \\ 0 & 0 & 1 / 3 & 0 & 0 & 1 / 3 & 1 / 3 \\ 0 & 0 & 0 & 0 & 1 & 0 & 0 \\ 1 / 3 & 1 / 3 & 0 & 1 / 3 & 0 & 0 & 0 \\ 0 & 0 & 0 & 0 & 1 & 0 & 0\end{matrix} ]$$

Accordingly, entry F_{1,1} is indicative of a ⅓ probability that input fund x₁ flows to output fund y₁. Entry F_{1,2} is indicative of a ⅓ probability that input fund x₂ flows to output fund y₁. Entry F_{1,3} is indicative of there being no flow between input fund x₃ and output fund y₁. Entry F_{1,4} is indicative of a ⅓ probability that input fund x₄ flows to output fund y₁. Entry F_{1,5} is indicative of there being no flow between fund x₅ and output fund y₁. Entry F_{1,6} is indicative of there being no flow between fund x₆ and output fund y₁. Entry F_{1,7} is indicative of there being no flow between fund x₇ and output fund y₁. Entry F_{2,1} is indicative of there being no flow between fund x₁ and output fund y₂. Entry F_{2,2} is indicative of there being no flow between fund x₂ and output fund y₂. Entry F_{2,3} is indicative of a ⅓ probability that input fund x₃ flows to output fund y₂. Entry F_{2,4} is indicative of there being no flow between fund x₄ and output fund y₂. Entry F_{2,5} is indicative of there being no flow between fund x₅ and output fund y₂. Entry F_{2,6} is indicative of a ⅓ probability that input fund x₆ flows to output fund y₂. Entry F_{2,7} is indicative of a ⅓ probability that input fund x₇ flows to output fund y₂. Entry F_{3,1} is indicative of there being no flow between fund x₁ and output fund y₃. Entry F_{3,2} is indicative of there being no flow between fund x₂ and output fund y₃. Entry F_{3,3} is indicative of there being no flow between fund x₃ and output fund y₃. Entry F_{3,4} is indicative of there being no flow between fund x₄ and output fund y₃. Entry F_{3,5} is indicative of there being a flow between fund x₅ and output fund y₃. Entry F_{3,6} is indicative of there being no flow between fund x₆ and output fund y₃. Entry F_{3,7} is indicative of there being no flow between fund x₇ and output fund y₃. Entry F_{4,1} is indicative of a ⅓ probability that input fund x₁ flows to output fund y₄. Entry F_{4,2} is indicative of a ⅓ probability that input fund x₂ flows to output fund y₄. Entry F_{4,3} is indicative of there being no flow between fund x₃ and output fund y₄. Entry F_{4,4} is indicative of a ⅓ probability that input fund x₄ flows to output fund y₄. Entry F_{4,5} is indicative of there being no flow between fund x₅ and output fund y₄. Entry F_{4,6} is indicative of there being no flow between fund x₆ and output fund y₄. Entry F_{4,7} is indicative of there being no flow between fund x₇ and output fund y₄. Entry F_{5,1} is indicative of there being no flow between fund x₁ and output fund y₅. Entry F_{5,2} is indicative of there being no flow between fund x₂ and output fund y₅. Entry F_{5,3} is indicative of there being no flow between fund x₃ and output fund y₅. Entry F_{5,4} is indicative of there being no flow between fund x₄ and output fund y₅. Entry F_{5,5} is indicative of there being a flow between fund x₅ and output fund y₅. Entry F_{5,6} is indicative of there being no flow between fund x₆ and output fund y₅. Entry F_{5,7} is indicative of there being no flow between fund x₇ and output fund y₅.

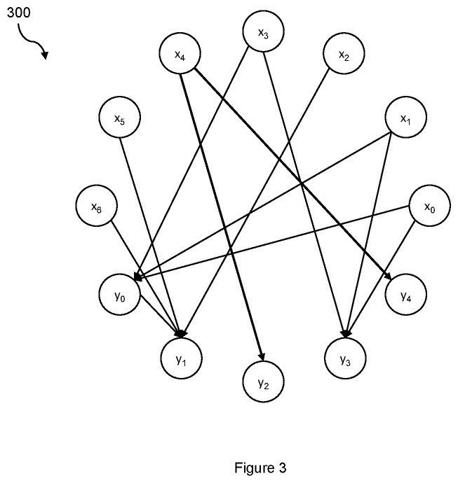

FIG. 3 depicts an estimated flow between the plurality of input funds xᵢ, and the plurality of output funds yⱼ, as solved by the method 200. As shown by the arrows connecting the input fund x₅ to the output funds y₃ and y₅, the solution of the method 200 indicates that there is a flow between the input fund x₅ and the output funds y₃ and y₅.

Therefore, the method 200 for identifying a connection between an input fund and an output fund using the computing system 100 provides a means for reconstructing flows between input funds xᵢ and output funds yⱼ by observing monetary amounts entering and exiting the processing node.

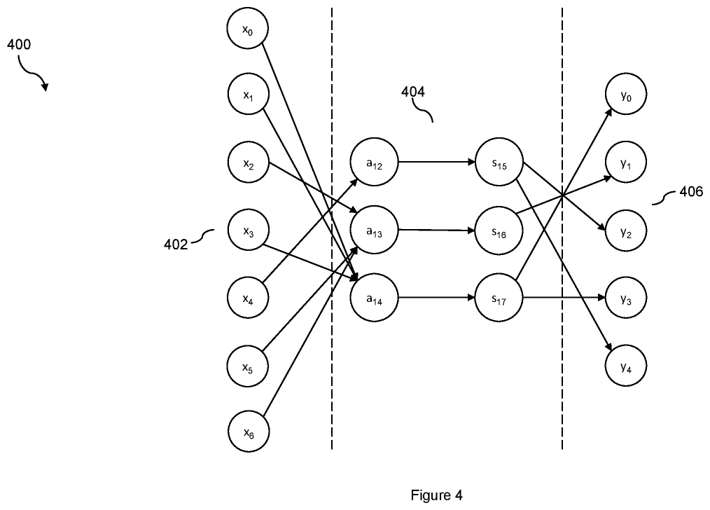

FIG. 4 depicts a flow 400 between a plurality of input funds xᵢ, and a plurality of output funds yⱼ based on the example of the method 200. The flow 400 utilises a processing node 402.

The processing node 402 may be a cryptocurrency tumbler and is configured to mix the input funds xᵢ in order to generate the output funds yⱼ. The processing node 402 comprises a plurality of aggregation nodes a₁₂, a₁₃, and a₁₄. The processing node also comprises a plurality of splitting nodes s₁₅, s₁₆, and s₁₇.

The aggregation node a₁₂ is configured to receive the input fund x₅, and provide the input fund x₅ to the splitting node s₁₅.

The aggregation node a₁₃ is configured to receive and aggregate the input funds x₃, x₆, and x₇ and provide the aggregated fund to the splitting node s₁₆.

The aggregation node a₁₄ is configured to receive and aggregate the input funds x₁, x₂, and x₄ and provide the aggregated fund to the splitting node s₁₆.

The splitting node s₁₅ is configured to receive the input fund x₅ and split it into the output funds y₃ and y₅.

The splitting node s₁₆ is configured to receive the aggregated input funds x₃, x₆, and x₇ and output it into the output fund y₂.

The splitting node s₁₇ is configured to receive the aggregated input funds x₁, x₂, and x₄, and split it into the output funds y₁ and y₄.

Accordingly, the processing node 402 has effectively mixed the input funds xᵢ, and a generated the output funds yⱼ

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An internal flow determination method comprising the steps of:
receiving, at a classical computer, an input flow vector comprising a plurality of input entries, said input entries being indicative of a monetary amount entering a processing node;
receiving, at a classical computer, an output flow vector comprising a plurality of output entries, said output entries being indicative of a monetary amount exiting the processing node;
determining, by the classical computer, an objective optimization problem subject to one or more constraints;
wherein an objective of the objective optimization problem is to determine:
an input flow matrix; and
an output flow matrix;
determining, by the classical computer, a quadratic unconstrained binary optimization (QUBO) formulation suitable for implementing the objective optimization problem;
solving, by a quantum computer, the QUBO formulation, thereby providing a solution representative of the input flow matrix and the output flow matrix; and
generating, by the classical computer, a probability matrix indicative of a probability that an internal flow of the processing node connects an input entry to an output entry.

2. The method of claim 1, wherein the probability matrix is obtained by multiplying the input flow matrix by a transpose of the output flow matrix.

3. The method of claim 2, wherein the probability matrix is an m by n matrix having entries indicative of a flow probability between an input fund and an output fund, wherein m is a vector length of the output flow vector, and wherein n is a vector length of the input flow vector.

4. The method of claim 1, wherein the one or more constraints comprise:
a left-stochastic constraint; and
an integer constraint.

5. The method of claim 4, wherein the left-stochastic constraint is configured to ensure that the input flow matrix and the output flow matrix are left-stochastic.

6. The method of claim 4, wherein the integer constraint is configured to limit entries of the input flow matrix and entries of the output flow matrix to a group of integers modulo 2.

7. The method of claim 4, wherein the one or more constraints further comprise:
a synchronicity constraint; and
a biasing constraint.

8. The method of claim 7, wherein the synchronicity constraint is configured to ensure that a time value associated with entries of the input flow vector is earlier than a time value associated with entries of the output flow vector that are linked to the entries of the input flow vector.

9. The method of claim 7, wherein the biasing constraint is configured to bias the solution according to patterns determined by a machine learning algorithm.

10. The method of claim 1, wherein the QUBO formulation is solved by an adiabatic quantum computer.
